(19) United States
(12) Patent Application Publication
(10) Pub. No.: US 2018/0236949 A1
(43) Pub. Date: Aug. 23, 2018

(54) PORTABLE TOOL MOUNTING DEVICE

(71) Applicants: Randy Whitehurst, Clear Lake, IA (US); Jason Whitehurst, Plymouth, IA (US)

(72) Inventors: Randy Whitehurst, Clear Lake, IA (US); Jason Whitehurst, Plymouth, IA (US)

(21) Appl. No.: 15/899,939

(22) Filed: Feb. 20, 2018

Related U.S. Application Data
(60) Provisional application No. 62/461,592, filed on Feb. 21, 2017.

(51) Int. Cl. B60R 11/06; B66F 3/08; B66F 3/44

(52) U.S. Cl. CPC B60R 11/06; E21B 7/028; B66F 3/44; B66F 3/08

(57) ABSTRACT

A portable tool mounting device has a frame, a tool mount member slidably mounted to the frame, and a motor connected to the frame and a threadable rod that extends through a bore in the tool mount member. Attached to the threadable rod is a nut that is positioned to engage the tool mount member.

### CROSS REFERENCE TO RELATED APPLICATION

This application claims the benefit to Provisional Application U.S. Ser. No. 62/461,592 filed on Feb. 21, 2017.

### BACKGROUND OF THE INVENTION

This invention is directed to a portable tool mounting device and more particularly to a device that is attached to a vehicle and a tool is easily attached to the device.

Tools for manual operation are well-known in the art. For example, power auger head drills are well-known for manually drilling holes in the ground, the ice, or the like. Often, the drilling location is in a remote, hard to access area. Because of the size and weight of the drill it is sometimes difficult to transport the drill to the location.

Also, some tools are difficult to manually operate due to an individual's size, strength, health and/or disability. Accordingly, a device is needed that addresses these deficiencies.

An objective of the present invention is to provide a portable tool mounting device that permits easy transport of tools to remote, hard to access areas.

Another objective of the present invention is to provide a portable tool mounting device that permits the easy operation of tools regardless of an individual's size, strength, health and/or disability.

These and other objectives will be apparent to those skilled in the art based upon the following written description, drawings, and claims.

### SUMMARY OF THE INVENTION

A portable tool mounting device having a frame with a top member, a bottom member, and at least one support brace. A tool member extends between the side members and has slide tubes on the ends that fit over and are slidably connected to the side members.

A motor is mounted to the frame and is connected to a threadable rod. The threadable rod extends through bores in the tool mount and the at least one support brace. Connected to the frame and the motor is a reverse polarity switch which controls the rotational drive of the motor.

### BRIEF DESCRIPTION OF THE DRAWINGS

FIG. 1 is a front view of a portable tool mounting device; and

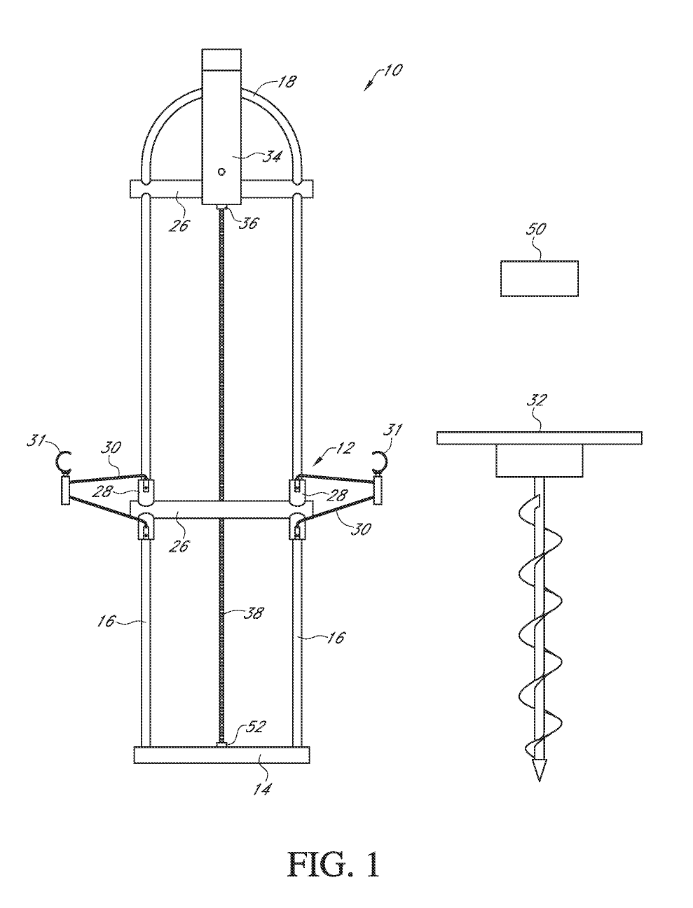

FIG. 2 is a side view of a portable tool mounting device.

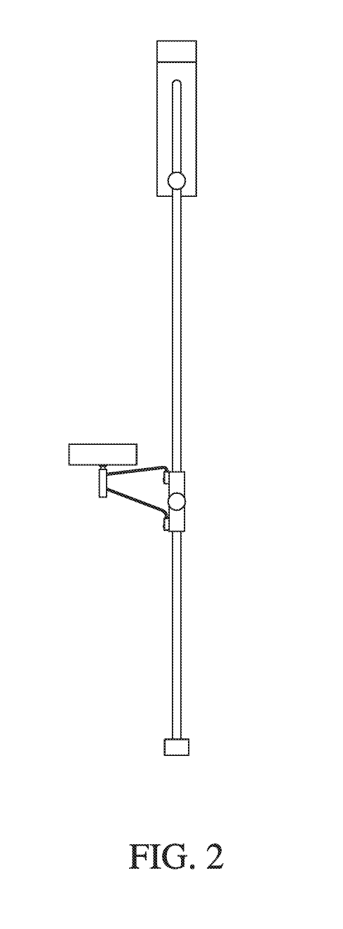

### DETAILED DESCRIPTION

Referring to the figures, a portable tool mounting device 10 has a frame 12. The frame 12 is of any size, shape, or structure. In a preferred example, as shown, the frame 12 has a bottom member 14 connected at its ends to a pair of side members 16 positioned in spaced parallel relation. The side members 14 extend away from the bottom member 12 and terminate in an arcuate or curved top member 18. The curve of the top member 16 increases the rigidity of the frame 12.

Connected to and extending between the side members 14 is a first 20 and a second 22 support brace. The first support brace 20 is adjacent the top member 18 and the second support brace 22 is adjacent the bottom member 14. Both the first and second support braces 20 and 22 have a central bore 24 that extends through the braces and dwells in the same vertical plane as the side members 16.

Positioned between the first and second support braces 20 and 22 and extending between and slidably connected to the side members 16 is a tool mount member 26. The tool mount member 26 is slidably connected to the side members 16 in any manner. In one example, as shown, connected at each end of the tool mount member 26 is a slide tube 28 that slidably fits around the side members 16. Connected to and extending outwardly from the slide tubes 28 are a pair of arms or brackets 30 that are connected to a tool 32. Attached to the end of arms 30 are supports 31. The tool 32 is of any type such as a power auger head drill, a jack hammer, lifting forks, lift container, or the like. Also extending through the tool mount member 26 in the same plane as the side members 16 is a bore 33. Bores 24 and 33 are vertically aligned.

Connected to the top member 18 of the frame 12 is a motor 34. The motor is of any size, shape, or structure. In a preferred example the motor 34 is a twelve volt DC electric motor. Operatively connected to the motor 34 is a clutch 36 and a threaded rod 38. The clutch 36 is used to adjust the pressure applied to the rod 38 to affect spin. The rod 38 extends from the motor 34 and through bores 24 and 33. A pair of bushings 40 and locking collars 42 are connected to the rod 38 and are positioned to engage the first and the second support braces 20 and 22. A threaded nut 44 is attached to rod 38 and is positioned to engage the tool mount member 26.

Mounted to the frame 12, and more preferably to the first support brace 20, is a reverse polarity switch 46. The switch 46 is wirelessly connected to the motor 34 to control the rotational drive of the motor 34. The switch 46 is also electrically connected to the battery of the vehicle 48. A remote control unit 50, such as a key fob, or the like, is wirelessly connected to the switch 46 to activate and control the switch 46.

The vehicle 48 is of any type such as an all-terrain vehicle, a pickup, or the like. The device 10 is mounted to the vehicle 48 in any manner. In one example, extending outwardly from the bottom member 14 of the frame 12 is a receiver tube 52 positioned to align with and fit over the receiver 54 of the vehicle 48. Alternatively a bracket extends outwardly from the bottom member 14 and is attached to the vehicle 48. Also, a pair of connecting members 57 are connected at one end to the frame 12 or first support brace 20 and extend to and are connected to the vehicle 48 at the opposite end.

In operation, once the device 10 is mounted to the vehicle 48, a tool 32 is connected to the arms or brackets 30 of the tool mount member 26. The pressure of the clutch 36 is set at a desired pressure and can be adjusted during operation. The tool 32 is activated in a conventional manner according to the start mechanism of the tool.

Next, the motor 34 is activated by using a switch or button 58 on the remote control unit 50. The control unit 50 sends a signal to switch 58 which in turn sends a signal to the motor 34 to control the rotational direction of the motors drive.

Once activated, the motor 34 rotates the threaded rod 38. As the threaded rod 38 rotates in a first direction through the threaded nut 44, the tool mount member 26 slides downwardly in relation to the side members 16 which in turn lowers the tool 32. When the motor 34 is reversed, the threaded rod 38 rotates in a second direction through the threaded nut causing the tool mount member 26 to move upwardly and raise the tool 32.

Accordingly, a portable tool mounting device has been disclosed that at the very least meets all the stated objectives.

What is claimed is:

1. A portable tool mounting device, comprising:
a frame;
a tool mount slidably mounted to the frame;
a motor connected to the frame and operatively connected to the tool mount to slide the tool mount upwardly and downwardly in relation to the frame.

2. The device of claim 1 wherein the frame has a top member, a bottom member, side members, and at least one support brace that extends between the side members.

3. The device of claim 1 wherein the tool member has slide tubes that are slidably connected to side members of the frame.

4. The device of claim 1 wherein a tool is connected to the tool mount.

5. The device of claim 4 wherein the tool is connected to a pair of arm brackets that extend outwardly from the tool mount.

6. The device of claim 1 wherein a threadable rod is rotatably connected to the motor.

7. The device of claim 6 wherein the threadable rod has a threaded nut positioned to engage the tool mount.

8. The device of claim 1 wherein a reverse polarity switch is mounted to the frame and connected to the motor.

9. The device of claim 8 wherein the reverse polarity switch is connected to a battery of a vehicle.

10. The device of claim 8 wherein the reverse polarity switch is connected to a remote control unit.
